(19) United States
(12) Patent Application Publication
(10) Pub. No.: US 2026/0236954 A1
(43) Pub. Date: Aug. 13, 2026

(54) METHODS AND SYSTEMS FOR PLANNING FRANCHISE MARKETING USING OFFLINE STORE DATA AND AI DEEP LEARNING ALGORITHMS

(71) Applicant: NEXTPAYMENTS INC., Seoul (KR)

(72) Inventor: Kwang Chol JEE, Anyang-si (KR)

(21) Appl. No.: 19/645,695

(22) Filed: Apr. 13, 2026

Related U.S. Application Data
(63) Continuation of application No. PCT/KR2024/015889, filed on Oct. 18, 2024.

(30) Foreign Application Priority Data
Oct. 18, 2023 (KR) 10-2023-0139233

(51) Int. Cl. G06Q 30/0203; G06Q 30/0251; G06Q 30/0273

(52) U.S. Cl. CPC G06Q 30/0203; G06Q 30/0254; G06Q 30/0273

(57) ABSTRACT

The disclosed embodiments relate to a method of processing various offline store data using an AI deep learning algorithm and of planning a marketing strategy of a franchise based on the same, and a system therefor. The system may analyze characteristics of a visiting customer, sales information, product information, order information, and the like using a specialized deep learning-based AI prediction algorithm, and can plan a marketing strategy of a franchise through the same. Analysis information and the marketing strategy can not only assist in a purchase decision of a consumer but also be utilized in establishing an advertisement and marketing operation strategy of a franchise headquarters. In addition, the analysis information and the marketing strategy can be provided in the form of a simple User Interface (UI) and a graph such that a store operator and a marketing manager can establish an efficient strategy.

### TECHNICAL FIELD

The present document relates to a method of planning marketing of a franchise using offline store data and an Artificial Intelligence (AI) deep learning algorithm and a system therefor. Specifically, the present document relates to a method and a system for analyzing characteristics of a visiting customer, sales information, product information, order information, and the like using a deep learning-based AI prediction algorithm, and deriving a marketing strategy helpful for the operation of a franchise therethrough.

### Background Art

A business model in which a franchisor provides a franchisee with professional knowledge on a business structure and use of related intellectual property rights such as its brand name, logo, business operation method (comprehensive utilization of intellectual property), service mark, and emblem, as well as basic raw materials, distribution channels, personnel management, and business activities is called a franchise chain business (affiliated store business). In this type of business model, the franchisor provides various business supports and management intervention according to contract terms, and enters into a transaction relationship to distribute economic compensation for such support. The franchise chain business includes a wide range of sectors, ranging from various food and beverage sales and distribution stores such as coffee shops, restaurants, and food services to offline and online retail stores, service-oriented distributors, and facility-based services (including game rooms, play areas, karaoke rooms, museums, libraries, coworking spaces, fitness clubs, sports facilities, and private academies including educational services).

For many years, companies have introduced various strategies to promote their products and services, satisfy current customers, and attract potential new customers. For example, companies promote their products and services through various promotional activities ranging from print media, such as newspapers, magazines, subway billboards, bus billboards, pamphlets, newsletters, press releases, and advertising signs, to sponsorship programs and seminars.

Performance marketing can establish, verify, and improve hypotheses regarding companies and products by utilizing data collected from online and offline channels. Recently, it is mainly used in online marketing that can accurately track various media and customer behavior.

As a result, in recent marketing strategies, it is considered more important to identify characteristics of customers to trigger their interest and deliver information at an appropriate time that can lead to sales, rather than simply determining through which channel an advertisement is exposed to which target.

### RELATED ART DOCUMENT

### Patent Document

[Patent Document 0001] Korean Patent Application No. 10-2020-0152110

### SUMMARY

### Technical Problem

Therefore, the present invention has been made in view of the above problems, and it is one object of the present invention to address the limitations of existing prior arts, including Korean Patent Application No. 10-2020-0152110 (SYSTEM AND METHOD FOR PROVIDING UNTACT SMART TOURIST SERVICE USING REGIONAL COMMERCIAL AREAS DATA), which merely disclose features of providing non-face-to-face or unmanned services using one of a sensor, a kiosk, a Point Of Sales (POS) device, and a table tablet, but are insufficient in terms of processing data obtained through an electronic device including a sensor, a kiosk, a POS device, or a table tablet and utilizing the same for marketing.

It is another object of the present invention to provide a method of planning marketing of a franchise using offline store data and an Artificial Intelligence (AI) deep learning algorithm and a system therefor according to the present document, which aims to analyze offline data obtained through an electronic device including a sensor, a kiosk, a POS device, or a table tablet using an AI learning model and to provide a marketing strategy suitable for a situation.

### Technical Solution

In accordance with an aspect of the present invention, the above and other objects can be accomplished by the provision of a system for planning marketing of a franchise using offline store data and an Artificial Intelligence (AI) deep learning algorithm, the system including: a processor; and a memory.

### Advantageous Effects

The present invention can process various offline store data using an Artificial Intelligence (AI) deep learning algorithm, and can assist in planning marketing of a franchise based on the processed data. A system according to the present document can analyze characteristics of a visiting customer, sales information, product information, order information, and the like using a deep learning-based AI prediction algorithm, and can plan a marketing strategy of the franchise through the analysis. Analysis information and the marketing strategy can not only assist in a purchase decision of a consumer but also assist in establishing a marketing and operation strategy of a franchise headquarters. In addition, a result of the analysis can be provided in a form of a simple UI and a graph so that a store operator and a marketing manager can establish an efficient strategy.

### BRIEF DESCRIPTION OF DRAWINGS

FIG. 1 is a block diagram illustrating the configuration of a system for planning marketing of a franchise according to an embodiment.

FIGS. 2A and 2B illustrate an appearance of an electronic device according to an embodiment.

FIG. 3 illustrates an embodiment of recognizing a face of a customer on a camera of a system according to an embodiment.

FIG. 4 illustrates a process of recognizing a face of a customer and displaying customer information on the camera of the system according to an embodiment.

FIG. 5 is a diagram for describing a system for planning a marketing strategy of an Artificial Intelligence (AI)-based franchise according to an embodiment.

FIG. 6 is a flowchart illustrating a method of planning marketing of a franchise using offline store data and an AI deep learning algorithm according to an embodiment.

### DETAILED DESCRIPTIONS OF EXEMPLARY EMBODIMENTS

### Description of Symbols

Hereinafter, embodiments will be described in detail with reference to the accompanying drawings. However, since various changes may be made to the embodiments, a scope of rights of the patent application is not limited or restricted by these embodiments. It should be understood that all changes, equivalents, or substitutes to the embodiments are included in the scope of rights.

Specific structural or functional descriptions of the embodiments are disclosed for illustrative purposes only and may be implemented in various forms. Therefore, the embodiments are not limited to specific disclosed forms, and the scope of the present specification includes changes, equivalents, or substitutes included in the technical spirit.

Terms such as first or second may be used to describe various components, but these terms should be interpreted only for the purpose of distinguishing one component from another component. For example, the first component may be named the second component, and similarly, the second component may also be named the first component.

When a component is referred to as being “connected” to another component, it should be understood that it may be directly connected or coupled to the other component, but another component may exist in between.

Terms used in the embodiments are used for descriptive purposes only and should not be interpreted as intending to limit. Singular expressions include plural expressions unless the context clearly indicates otherwise. In the present specification, terms such as “include” or “have” are intended to designate that features, numbers, steps, operations, components, parts, or combinations thereof described in the specification exist, but should be understood as not precluding the possibility of existence or addition of one or more other features, numbers, steps, operations, components, parts, or combinations thereof.

Unless defined otherwise, all terms used herein, including technical or scientific terms, have the same meaning as commonly understood by those skilled in the art to which the embodiments belong. Terms such as those defined in commonly used dictionaries should be interpreted as having meanings consistent with meanings in the context of related art, and should not be interpreted in an ideal or excessively formal sense unless explicitly defined in the present application.

In addition, in the description with reference to the accompanying drawings, identical components are assigned identical reference numerals regardless of reference numerals, and redundant descriptions thereof will be omitted. When describing the embodiments, if it is determined that a detailed description of related known technologies may unnecessarily obscure the gist of the embodiments, the detailed description thereof will be omitted.

The embodiments may be implemented as various types of products such as personal computers, laptop computers, tablet computers, smart phones, televisions, smart home appliances, intelligent vehicles, kiosks, wearable devices, and the like.

An artificial intelligence (AI) system is a computer system that implements human-level intelligence, and unlike a conventional rule-based smart system, it is a system in which a machine learns and makes a judgment by itself. As the AI system is used, a recognition rate may be improved and a user's preference may be understood more accurately, so that the conventional rule-based smart system is being gradually replaced by a deep learning-based AI system.

AI technology consists of machine learning and component technologies utilizing machine learning. Machine learning is an algorithm technology that classifies/learns features of input data by itself, and the component technology is a technology for mimicking functions such as cognition and judgment of a human brain by utilizing a machine learning algorithm such as deep learning, and consists of technical fields such as linguistic understanding, visual understanding, reasoning and prediction, knowledge representation, and motion control.

Various fields to which the AI technology is applied are as follows. Linguistic understanding is a technology for recognizing and applying/processing human language/characters, and includes natural language processing, machine translation, a dialogue system, a query and response, speech recognition/synthesis, and the like. Visual understanding is a technology for recognizing and processing an object like human vision, and includes object recognition, object tracking, image search, human recognition, scene understanding, spatial understanding, image improvement, and the like. Reasoning and prediction is a technology for logically reasoning and predicting by judging information, and includes knowledge/probability-based reasoning, optimization prediction, preference-based planning, recommendation, and the like. Knowledge representation is a technology for automatically processing human experience information into knowledge data, and includes knowledge construction (data generation/classification), knowledge management (data utilization), and the like. Motion control is a technology for controlling autonomous driving of a vehicle and a movement of a robot, and includes movement control (navigation, collision, driving), manipulation control (behavior control), and the like.

Generally, so as to apply a machine learning algorithm to real life, learning is performed in a trial and error manner due to characteristics of a basic methodology of machine learning. In particular, in a case of deep learning, hundreds of thousands of repeated executions may be required. Since it is impossible to execute this in an actual physical external environment, the actual physical external environment is instead virtually implemented on a computer, and learning is performed through simulation.

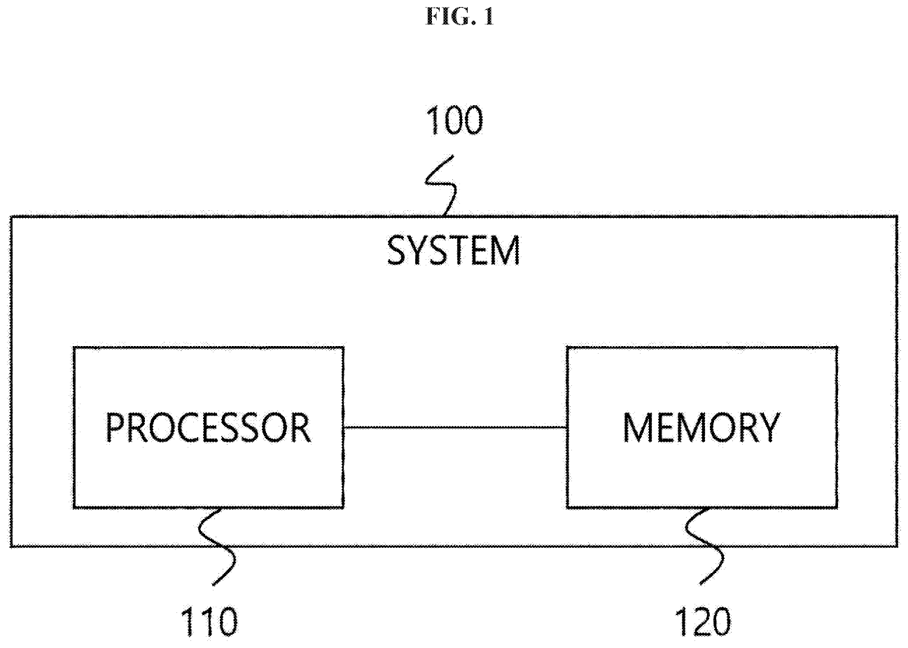

FIG. 1 is a block diagram illustrating the configuration of a system for planning marketing of a franchise according to an embodiment.

According to an embodiment, a system 100 may include a processor 110 and a memory 120. The system 100 according to a specific implementation example may be a server or a terminal. The memory 120 may store information, related to the aforementioned method, or a program in which the method is implemented. The memory 120 may be a volatile or non-volatile memory.

The implementation examples described above may be realized by a hardware element, a software element, or a combination of hardware and software elements. For example, the device, the method, and components described in these implementation examples may be realized using a general-purpose computer or a special-purpose computer, and as elements used in such a computer, any other kind of device that executes and responds to instructions, such as a processor, a controller, an Arithmetic Logic Unit (ALU), a Digital Signal Processor (DSP), a microcomputer, a Field Programmable Gate Array (FPGA), a Programmable Logic Unit (PLU), and a microprocessor, is possible.

The processor 110 may execute an operating system (OS) and one or more software applications executed thereon, and may additionally access, store, modify, and generate data in response to the execution of the software. For ease of understanding, those skilled in the art may recognize that a processing device may include a plurality of processing elements or various types of processing elements even if not otherwise specified. For example, the processor 110 may include a plurality of processors or one processor and one controller, and may include other processing configurations such as a parallel processor.

Software may include a computer program, coding, an instruction, and the like, or may operate the processor 110 in a desired manner through a combination thereof, or may individually or collectively instruct a processing device. Software and/or data may be expressed temporarily or permanently in various types of machines, components, actual equipment, virtual devices, computer storage media or devices, or transmission signal waves to be interpreted by the processing device or to provide instructions or data to the device. Software may be distributed, stored, or executed in a networked computer system. Software and data may be stored in one or more computer-readable storage media.

Although the implementation examples described above have been described with a limited number of drawings, those skilled in the art will recognize that various technical modifications and variations may be applied based on the aforementioned content. For example, even if the described techniques are executed in a different order, or elements such as the described system, structure, equipment, and circuit are combined or assembled in different forms, it is possible to achieve an appropriate result. In addition, such elements may be substituted or replaced with other components or equivalent items.

According to an embodiment, there may be no limit to calculation and data processing functions that the processor 110 may implement on an electronic device, but hereinafter, a function of planning marketing of a franchise will be described.

According to an embodiment, the processor 110 may receive data of a visiting customer collected from an electronic device including at least one of a sensor, a kiosk, a Point Of Sales (POS) device, and a table tablet, and may input the same into an AI learning model. The processor 110 may analyze at least one of characteristics of the visiting customer, sales information, or order information using the AI learning model, and may output a marketing strategy based on the analyzed information. The processor 110 may display analysis information outputted from the AI learning model in a graph form and may guide the marketing strategy onto a user terminal.

According to an embodiment, the processor 110 may receive data on movement paths of customers and time slots with a high floating population from a sensor, receive data on gender, age, and order information of visiting customers from a kiosk or a POS device, or receive data on the number of people visiting a store and the number of customers sitting at a specific table in the store from a table tablet. The processor 110 may provide the received data as an input to the AI learning model.

According to an embodiment, the processor 110 may provide a guide on the number of personnel required at a time of startup based on information on a time slot with the most orders and information on an order quantity, and may provide a guide on a recommended business type and a recommended product at the time of startup based on information on types of products and business types sold most within a first zone. The first zone may include an area within a specified distance based on one electronic device (e.g., a kiosk).

According to an embodiment, the processor 110 may determine a zone within a radius of 5 km from another electronic device as a second zone when the number of people passing around the other electronic device (e.g., a kiosk) for a specified time (e.g., 10 minutes) exceeds a specified level (e.g., 100 people). The radius of 5 km is merely an example, and a range of the second zone may vary according to settings.

The processor 110 may obtain information on a gender and age of people making orders within the second zone, information on types of products and business types sold most within the second zone, information on a time slot with the most orders, and information on order quantity, by using other electronic devices located within the second zone.

The processor 110 may select information on the first zone and the second zone based on gender and age information of target customers at a time of startup. The processor 110 may compare a product and a business type sold most within the first zone with a product and a business type sold most within the second zone, and may provide a guide on a recommended business type and a recommended product at the time of startup based on a result of the comparison.

According to an embodiment, the processor 110 may recommend selecting a business type sold most within the second zone for startup based on the absence of an electronic device corresponding to the business type in the first zone.

According to an embodiment, the processor 110 may recommend selecting a business type sold most within the second zone for startup based on the number of electronic devices corresponding to the business type in the first zone being less than a specified number (e.g., 3). The specified number (e.g., 3) is merely an example, and the number of electronic devices for recommending the startup may vary according to settings.

The processor 110 may recommend not selecting a business type sold most within the second zone for startup based on the number of electronic devices corresponding to the business type in the first zone exceeding a specified number (e.g., 10).

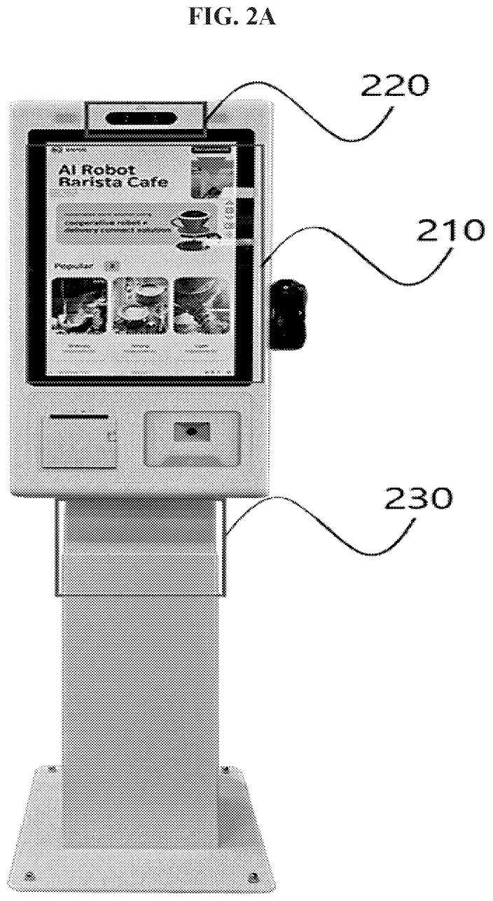

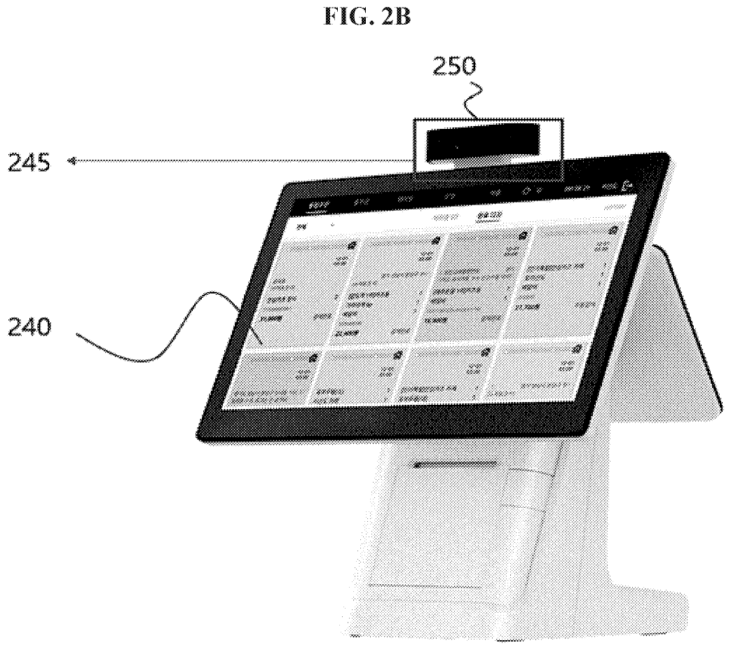

FIGS. 2A and 2B illustrate an appearance of the electronic device according to an embodiment.

A system (e.g., the system of FIG. 1) may include the electronic device. The system 100 may receive data of a visiting customer collected from the electronic device.

The electronic device may include, for example, at least one of a sensor, a kiosk, a POS (point of sales) device, and a table tablet.

The electronic device may determine a type and quantity of a menu selected by a customer based on an input on a display 210 and may transmit information to a server. A server administrator may check order details of the customer using the received information and may provide a service according to the order details.

The electronic device may capture an appearance of the customer using a camera 220 and may determine personal information (e.g., gender, age group, height) of the customer. The electronic device may detect a movement of customers by continuously operating the camera 220, or may start operating the camera 220 based on a customer input being detected on the display 210.

According to an embodiment, a processor (e.g., the processor 110 of FIG. 1) may capture the appearance of the customer using the camera 220 based on the customer input being detected on the display 210, obtain information on a face, a height, a shoulder skeleton, and a hair length of the customer by analyzing the captured appearance of the customer, determine a gender and an age group of the customer based on the information on the face, the height, the shoulder skeleton, and the hair length of the customer, determine a list of products suitable for the customer based on product purchase quantities and user review scores of other customers having the same gender and age group as the customer, and display the list on the display 210.

The system 100 may further include a distance measurement sensor in addition to the camera 220. The system 100 may use the distance measurement sensor to start capturing or recognizing a customer approaching within a specified level from the electronic device using the camera 220. Alternatively, the system 100 may start capturing or recognizing using the camera 220 based on an input being detected on the display 210.

In FIG. 2b, the electronic device may include, for example, a POS device. The electronic device may include a camera 250. The electronic device may display a display 240 to a customer and capture the customer in a direction 245. The electronic device may obtain order information of the customer based on an input on the display 240. The electronic device may obtain customer information including a gender and age group of the customer from the appearance of the customer captured by the camera 250.

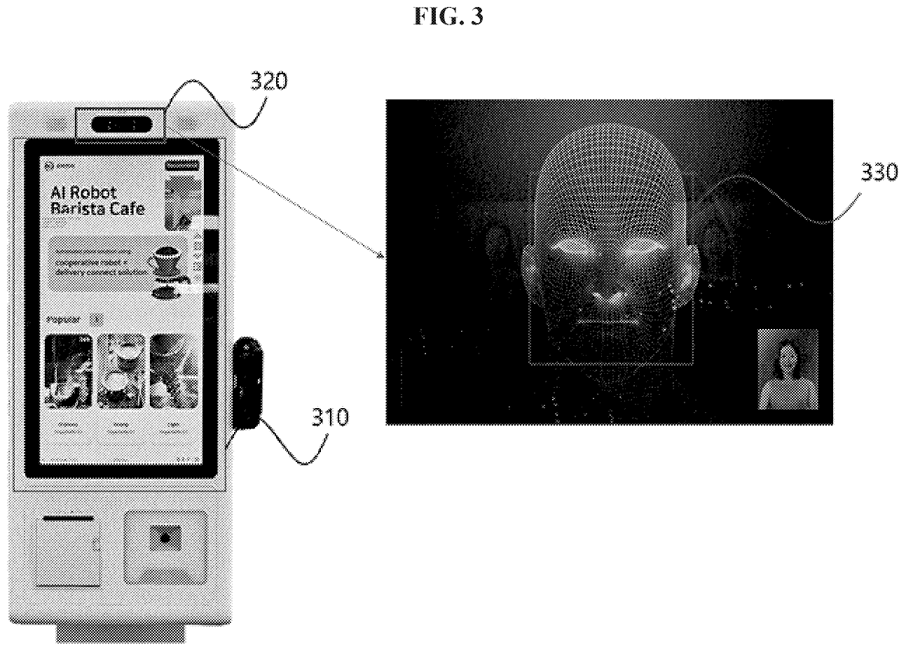

FIG. 3 illustrates an embodiment of recognizing a face of a customer on a camera of a system according to an embodiment.

In FIG. 3, an electronic device may include a display 310 and a camera 320. The electronic device may recognize a face and body part of the customer using the camera 320.

A drawing 330 of FIG. 3 illustrates a situation of recognizing the face of the customer and inferring personal information (e.g., gender, age group, height) of the customer based on recognized information.

According to an embodiment, a processor (e.g., the processor 110 of FIG. 1) may determine an age group of the customer based on information on the face, height, shoulder skeleton, and hair length of the customer, and may receive product purchase records of other customers having the same age group as the determined age group of the customer.

The processor 110 may receive the product purchase records of other customers having the same age group from an external server. The external server may include information on kiosks and POS devices of other companies selling same types of products as the system 100. For example, when the system 100 is used in a cafe for a food and beverage business, the external server may obtain information on customer orders from a plurality of kiosks and POS devices used in other cafes.

For example, when the processor 110 recognizes that the customer is a male in a 30s age group using the camera 320, the processor 110 may receive cafe order records corresponding to the male in a 30s age group from the external server. The system 100 may determine a list of products recommendable to the male in a 30s age group based on the received information, and may display the list on the display 310. The cafe, the 30s age group, and the male are merely examples, and a business type and a gender and an age group of a customer may vary according to settings. The external server may determine to provide information on a same business type in a case of kiosks and POS devices of a same franchise company.

The processor 110 may display recommended products in a descending order of cumulative purchase amounts of other customers for a specified period (e.g., 3 months) based on a current time point, and may display a product, for which a cumulative purchase amount during the specified period based on the current time point has increased by exceeding a first level (e.g., 50%) compared to a cumulative purchase amount during a specific past period, as a rising popularity product.

The cumulative purchase amount of other customers during the specified period based on the current time point may mean, for example, a cumulative purchase amount for past 3 months based on the current time point, or may mean a cumulative purchase amount for past 1 month based on the current time point. The cumulative purchase amount during the specific past period may mean, for example, a cumulative purchase amount from 3 months ago to 6 months ago based on the current time point, or may mean a cumulative purchase amount from 3 months ago to 4 months ago based on the current time point. A current sales amount serving as a reference and a previous sales amount serving as a comparison target may vary according to period settings. The specified period (e.g., 3 months) and the specified level (e.g., 50%) are merely examples and may vary according to settings.

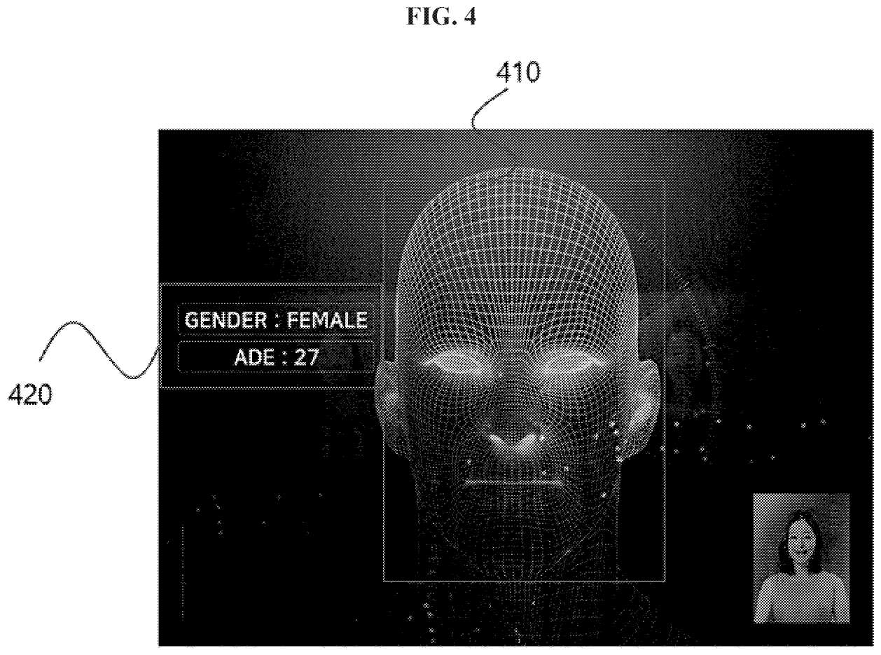

FIG. 4 illustrates a process of recognizing a face of a customer and displaying customer information on the camera of the system according to an embodiment.

In FIG. 4, the system (e.g., the system 100 of FIG. 1) may recognize a face and body part (e.g., an upper body, a shoulder) of a customer using a camera (e.g., the camera 220 of FIG. 2). Alternatively, the system 100 may determine information on the number of people located in a specified zone and a floating population based on information received from at least one sensor.

In FIG. 4, the system 100 may recognize a face 410 and body part of the customer using the camera 220. The camera may include, for example, a vision camera or a thermal infrared camera. The system 100 may detect other customers passing behind in addition to the customer inputting an order. The system 100 may distinguish whether a person is the customer currently inputting the order onto the system 100 or a passing person based on a distance from the customer. Alternatively, the system 100 may distinguish whether the person is the customer currently inputting the order onto the system 100 or a passing person based on a body size.

When the customer places an order on a kiosk, the customer may approach within a specified distance for input. When the customer approaches within the specified distance based on the kiosk, the body size of the customer may be measured to be at least a certain level. On the other hand, in a case of a person passing from a distance, a body size of the person may be measured by the camera on the kiosk, but may be measured relatively small because a distance is far. The processor 110 may determine that the person is the passing person even without measuring the distance from the customer when the body size is measured to be smaller than a specific level.

Drawing 420 of FIG. 4 illustrates a situation of inferring and displaying personal information of the customer using the camera 220 on the system 100. For example, the system 100 may determine that a gender of the customer is female and an age thereof is 27 years old, and may display the same on a display (e.g., the display 310 of FIG. 3).

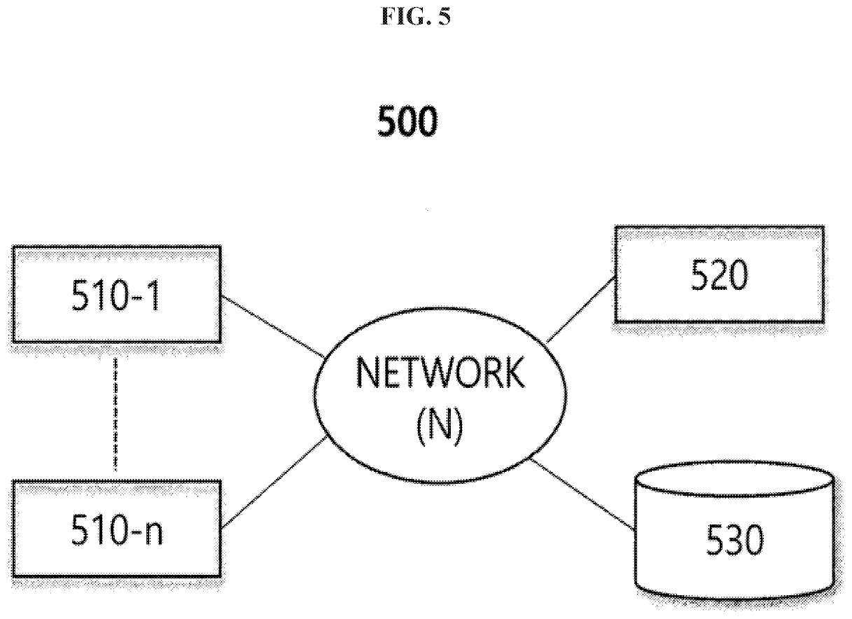

FIG. 5 is a diagram for describing a system for planning a marketing strategy of an AI-based franchise according to an embodiment.

As shown in FIG. 5, a system 500 for planning a marketing strategy of an AI-based franchise may include a plurality of user terminals 510-1, . . . , 510-n, a server 520, and a database 530. According to an embodiment, although the database 530 is illustrated as being configured separately from the server 520, it is not limited thereto, and the database 530 may be provided within the server 520. For example, the server 520 may include a plurality of AIs for performing a machine learning algorithm. According to an embodiment, the plurality of user terminals 510-1, . . . , 510-n, the server 520, and the database 530 may be connected to communicate with each other through a network N.

The network N may allow wireless or wired communication to be performed between the plurality of user terminals 510-1, . . . , 510-n, the server 520, the database 530, and the like. For example, the network may perform wireless communication according to a method such as Long-Term Evolution (LTE), LTE Advanced (LTE-A), Code Division Multiple Access (CDMA), Wideband CDMA (WCDMA), Wireless Broadband (WiBro), Wireless Fidelity (WiFi), Bluetooth, Near Field Communication (NFC), Global Positioning System (GPS), or Global Navigation Satellite System (GNSS). For example, the network N may perform wired communication according to a method such as Universal Serial Bus (USB), High Definition Multimedia Interface (HDMI), Recommended Standard 232 (RS-232), or Plain Old Telephone Service (POTS).

The database 530 may store various data. Data stored in the database 530 is data obtained, processed, or used by at least one component of the plurality of user terminals 510-1, . . . , 510-n and the server 520, and may include software (e.g., a program). The database 530 may include a volatile and/or non-volatile memory.

In the present invention, Artificial Intelligence (AI) refers to a technology that mimics human learning ability, reasoning ability, perception ability, and the like and implements the same with a computer, and may include concepts such as machine learning and symbolic logic. Machine Learning (ML) may refer to an algorithm technology that classifies or learns features of input data by itself. AI technology may analyze input data as a machine learning algorithm, learn a result of the analysis, and make a judgment or prediction based on a result of the learning. In addition, technologies that mimic functions such as cognition and judgment of a human brain using a machine learning algorithm may also be understood as a category of AI. For example, technical fields such as linguistic understanding, visual understanding, reasoning/prediction, knowledge representation, and motion control may be included.

Machine learning may refer to a process of training a neural network model using experience of processing data. Through machine learning, computer software may improve data processing capability by itself. A neural network model is constructed by modeling a correlation between data, and the correlation may be expressed by a plurality of parameters. The neural network model extracts and analyzes features from given data to derive a correlation between data, and optimizing parameters of the neural network model by repeating this process may be referred to as machine learning. For example, the neural network model may learn a mapping (correlation) between an input and an output with respect to data given as an input/output pair. Alternatively, even when only input data is given, the neural network model may derive regularity between the given data and learn a relationship thereof.

An AI learning model or a neural network model may be designed to implement a human brain structure on a computer, and may include a plurality of network nodes that simulate neurons of a human neural network and have weights. The plurality of network nodes may simulate synaptic activity of neurons exchanging signals through synapses, and may have a connection relationship with each other. In the AI learning model, the plurality of network nodes are located in layers of different depths and may exchange data according to a convolution connection relationship. The AI learning model may be, for example, an Artificial Neural Network (ANN), a Convolution Neural Network (CNN), or the like. According to an embodiment, the AI learning model may be machine-learned according to a method such as supervised learning, unsupervised learning, reinforcement learning, or the like. As a machine learning algorithm for performing machine learning, a decision tree, a Bayesian network, a support vector machine, an artificial neural network, Ada-boost, a perceptron, genetic programming, clustering, or the like may be used.

Among them, a CNN is a type of multilayer perceptrons designed to use minimal preprocessing. The CNN consists of one or several convolutional layers and general artificial neural network layers placed thereon, and additionally utilizes weights and pooling layers. Due to this structure, the CNN can sufficiently utilize input data of a 2-dimensional structure. Compared to other deep learning structures, the CNN shows good performance in both image and voice fields. The CNN may also be trained through standard backpropagation. The CNN has an advantage that it is easier to train than other feedforward artificial neural network techniques and uses a small number of parameters.

Convolutional networks are neural networks including sets of nodes having tied parameters. An increase in a size of available training data and availability of computing power are combined with algorithmic advances such as piecewise linear units and dropout training, so that many computer vision tasks have been significantly improved. In huge datasets such as datasets available for many tasks today, overfitting is not important, and increasing a size of a network improves test accuracy. Optimal use of computing resources becomes a limiting factor. To this end, a distributed and scalable implementation of deep neural networks may be used.

An AI model according to an embodiment may include an input layer, a hidden layer, and an output layer.

The input layer is a layer related to an input value inputted to the AI model.

The hidden layer may perform a multiply-accumulate (MAC) operation and an activation operation on an input value to output a feature map.

The MAC operation may be an operation of multiplying the input value and a corresponding weight, respectively, and summing the multiplied values.

The activation operation may be an operation of inputting a result of the MAC operation into an activation function and outputting a result value. The activation function may be of various types. For example, the activation function may include a sigmoid function, a tangent function, a ReLU function, a leaky ReLU function, a maxout function, and/or an ELU function, but the type is not limited thereto.

The hidden layer may consist of at least one layer. For example, when the hidden layer consists of a first hidden layer and a second hidden layer, the first hidden layer outputs a feature map by performing the MAC operation and the activation operation based on an input value of the input layer, and the feature map, which is a result value in the first hidden layer, may become an input value in the second hidden layer. The second hidden layer may perform the MAC operation and the activation operation based on the feature map which is the result value of the first hidden layer.

The output layer may be a layer related to a result value of an operation performed in the hidden layer.

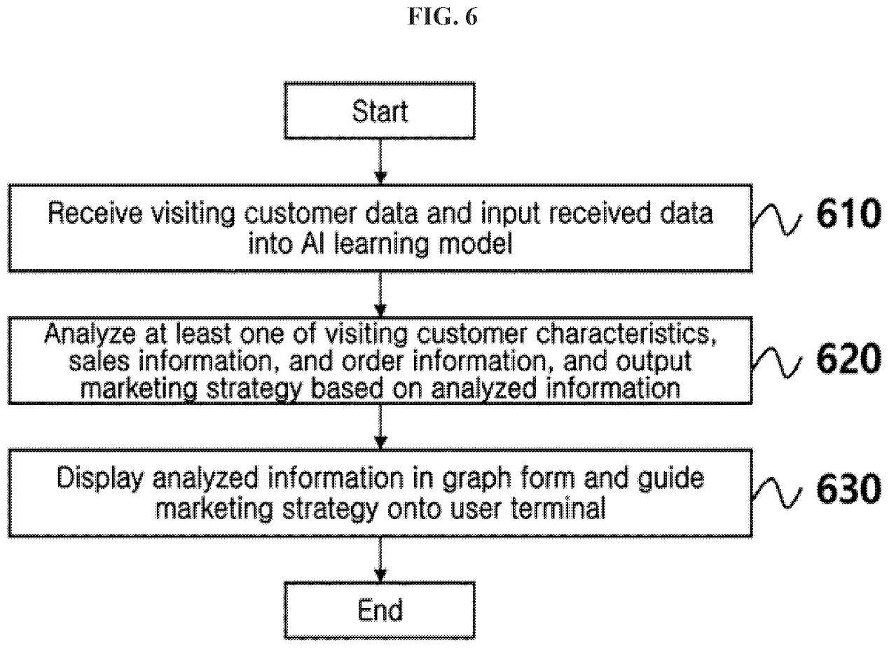

FIG. 6 is a flowchart illustrating a method of planning marketing of a franchise using offline store data and an AI deep learning algorithm according to an embodiment.

Although process steps, method steps, algorithms, and the like are described in a sequential order in the flowchart of FIG. 6, such processes, methods, and algorithms may be configured to operate in any suitable order. Steps of processes, methods, and algorithms described in various embodiments of the present invention do not need to be performed in the order described in the present invention.

In addition, even if some steps are described as being performed non-simultaneously, such some steps may be performed simultaneously in other embodiments. Also, illustration of a process by depiction in the drawings does not mean that the illustrated process excludes other variations and modifications thereto, does not mean that the illustrated process or any of its steps is essential to one or more of various embodiments of the present invention, and does not mean that the illustrated process is preferred.

In operation 610, the processor (e.g., the processor 110 of FIG. 1) may receive data of a visiting customer and input the same into an AI learning model.

According to an embodiment, the processor 110 may receive data on movement paths of customers and time slots with a high floating population from a sensor, receive data on gender, age, and order information of visiting customers from a kiosk or a POS device, or receive data on the number of people visiting a store and the number of customers sitting at a specific table in the store from a table tablet. The processor 110 may provide the received data as an input to the AI learning model.

In operation 620, the processor 110 may analyze at least one of characteristics of the visiting customer, sales information, or order information, and may output a marketing strategy based on the analyzed information.

According to an embodiment, the AI learning model may receive data on the number of customers sitting at a specific table from a table tablet as an input, and may output ratios for a case where a customer visits the store alone, a case where two people visit together, a case where three people visit together, a case where four people visit together, and a case where five or more people visit together. The processor 110 may provide a marketing strategy for a product based on the ratio outputted from the AI learning model.

According to an embodiment, the AI learning model may receive data on a gender, an age, and order information of visiting customers from a kiosk or a POS device as an input, and may output a gender and an age group that are relatively most frequent for each time slot. The processor 110 may provide a marketing strategy for an advertisement based on the output ratio.

In operation 630, the processor 110 may display analysis information in a graph form and guide the marketing strategy outputted from the AI learning model onto a user terminal.

According to an embodiment, the processor 110 may display ratios for the case where the customer visits alone, the case where two people visit together, the case where three people visit together, the case where four people visit together, and the case where five or more people visit together in a graph on a monthly basis, a weekly basis, a daily basis, and an hourly basis.

The processor 110 may display a guide recommending separating a group table and arranging a relatively large number of tables for two people in a time slot where a sum of a ratio of customers visiting alone and a ratio of customers visiting together with two people is relatively higher than that of remaining types.

The processor 110 may display a guide recommending arranging group tables without separating them in a time slot where a sum of a ratio of customers visiting together with three people and a ratio of customers visiting together with four people is relatively higher than that of remaining types.

The processor 110 may display a guide recommending combining tables for two people to make a group table and arranging the same in a time slot where a ratio of customers visiting together with five or more people is relatively higher than that of remaining types.

According to an embodiment, the processor 110 may display a guide to display an advertisement targeting females in 10s and 20s age groups on a kiosk and a table tablet device in a time slot where the females in the 10s and 20s age groups are relatively most frequent among visiting customers.

The processor 110 may display a guide to display an advertisement targeting males in 10s and 20s age groups on the kiosk and the table tablet device in a time slot where the males in the 10s and 20s age groups are relatively most frequent among visiting customers.

The processor 110 may display a guide to display an advertisement targeting females in 30s and 40s age groups on the kiosk and the table tablet device in a time slot where the females in the 30s and 40s age groups are relatively most frequent among visiting customers, and may display a guide to display an advertisement targeting males in 30s and 40s age groups on the kiosk and the table tablet device in a time slot where the males in the 30s and 40s age groups are relatively most frequent among visiting customers.

The processor 110 may display a guide to display an advertisement targeting females in 50s and 60s age groups on the kiosk and the table tablet device in a time slot where the females in the 50s and 60s age groups are relatively most frequent among visiting customers, and may display a guide to display an advertisement targeting males in 50s and 60s age groups on the kiosk and the table tablet device in a time slot where the males in the 50s and 60s age groups are relatively most frequent among visiting customers.

According to an embodiment, the processor 110 may display a guide recommending relatively lowering a height of a kiosk in a time slot outputted as that a ratio of females among visiting customers exceeds a specified level (e.g., the ratio of females is twice as high as a ratio of males) compared to the ratio of males, and may display a guide recommending relatively raising the height of the kiosk in a time slot output as that the ratio of males among visiting customers exceeds a specified level compared to the ratio of females.

According to an embodiment, the processor 110 may classify a first zone, in which a time occupied by a floating population exceeds a specified level, and a second zone, in which a time occupied by the floating population is less than the specified level within a specified space, using the AI learning model, and may receive data on gender, age, and order information of visiting customers from a kiosk or a POS device as an input to output a gender and an age group that are relatively most frequent for each time slot.

The processor 110 may determine a gender and an age group that are most frequent among customers based on the time slot, and may provide a guide so that an advertisement targeting the most frequent gender and age group is displayed in the first zone.

The processor 110 may determine a rank of a plurality of advertisements for each advertisement unit price, provide a guide so that an advertisement having the highest advertisement unit price is arranged in the first zone, and provide a guide so that an advertisement having the lowest advertisement unit price is arranged in the second zone.

The processor 110 may classify a first zone, where a time occupied by a floating population exceeds a specified level, and a second zone, where a time occupied by the floating population is less than the specified level within a specified space, using an AI learning model.

According to an embodiment, the processor 110 may identify movement paths of customers waiting for an order through the kiosk using a sensor, identify movement paths of customers waiting for an order to a clerk other than the kiosk, and recommend moving a location of the kiosk to an area further away from the clerk when an overlapping area of the movement paths of the customers waiting for the order through the kiosk and the movement paths of the customers waiting for the order to the clerk exceeds a specified level.

According to an embodiment, the processor 110 may recommend maintaining the location of the kiosk when the overlapping area of the movement paths of the customers waiting for the order through the kiosk and the movement paths of the customers waiting for the order to the clerk is less than a specified level.

According to an embodiment, even after moving the location of the kiosk to the area further away from the clerk, the processor 110 may identify the movement paths of the customers waiting for the order through the kiosk using the sensor, identify the movement paths of the customers waiting for the order to the clerk other than the kiosk, and recommend increasing the number of kiosks for receiving orders when the overlapping area of the movement paths of the customers waiting for the order through the kiosk and the movement paths of the customers waiting for the order to the clerk exceeds the specified level.

According to an embodiment, the processor 110 may receive data on the number of customers sitting at a specific table in a store from a table tablet, and may receive information on a time during which the specific table in the store is occupied by the customers and a time during which the specific table is empty without being occupied, using a sensor. The processor 110 may determine a first table for which a ratio of the time occupied by customers during business hours exceeds a specified level, determine that a location where the first table is arranged is a seat with high customer satisfaction or convenience, and provide a guide to guide at least four or more customers to sit at the first table.

According to an embodiment, the processor 110 may determine a second table for which the ratio of the time occupied by the customers during business hours is less than a specified level, and may determine that a location where the second table is arranged is a seat with low customer satisfaction or inconvenience. The processor 110 may provide a guide to arrange a small-sized table so that one or two visiting customers can sit at the second table, and to guide a customer to sit at the second table when all other tables are occupied by customers.

According to an embodiment, the processor 110 may provide a guide to arrange a product with a highest margin or to arrange a popular product, of which a sales volume in other stores exceeds a specified level, in the first zone where a time occupied by a floating population exceeds a specified level within a specified space, and provide a guide to use the second zone, where the time occupied by the floating population is less than the specified level, as a warehouse or not to arrange the popular product in the second zone.

According to an embodiment, the processor 110 may receive data on a sales volume of a product, arranged in the first zone, from a POS device. The processor 110 may provide a guide recommending replacing the product arranged in the first zone when the sales volume of the product arranged in the first zone is less than a specified level, and provide a guide recommending maintaining the product arranged in the first zone when the sales volume of the product arranged in the first zone exceeds the specified level.

According to an embodiment, the processor 110 may receive data on movement paths of customers and time slots with a high floating population from the sensor, determine a time slot, in which the floating population exceeds a specified level, and a time slot, in which the floating population is less than the specified level, within a store, provide a guide to increase the number of clerks or the number of kiosks in the time slot where the floating population exceeds the specified level, and provide a guide to install a signboard in a first zone, where the time occupied by the floating population exceeds the specified level, so that contact or collision between different customers does not occur.

1. A system for planning marketing of a franchise using offline store data and an Artificial Intelligence (AI) deep learning algorithm, the system comprising:
a processor; and
a memory,
wherein the processor:
receives data of a visiting customer collected from an electronic device comprising at least one of a sensor, a kiosk, a Point Of Sales (POS) device, and a table tablet, and inputs the received data into an AI learning model;
analyzes at least one of characteristics of the visiting customer, sales information, and order information using the AI learning model, and outputs a marketing strategy based on the analyzed information; and
displays analysis information outputted from the AI learning model in a graph form, and guides the marketing strategy onto a user terminal.

2. The system according to claim 1, wherein the processor:
receives data on movement paths of customers and time slots with a high floating population from the sensor; or
receives data on gender, age, and order information of visiting customers from the kiosk or the POS device; or
receives data on the number of people visiting a store and the number of customers sitting at a specific table in the store from the table tablet, and
provides the received data as an input to the AI learning model.

3. The system according to claim 1, wherein the AI learning model receives data on the number of customers sitting at a specific table from the table tablet as an input and outputs ratios for a case where a customer visits the store alone, a case where two people visit together, a case where three people visit together, a case where four people visit together, and a case where five or more people visit together, and
the processor provides a marketing strategy for a product based on the outputted ratios.

4. The system according to claim 3, wherein the processor:
displays ratios for the case where the customer visits alone, the case where two people visit together, the case where three people visit together, the case where four people visit together, and the case where five or more people visit together in a graph on a monthly basis, a weekly basis, a daily basis, and an hourly basis;
displays a guide recommending separating a group table and arranging a relatively large number of tables for two people in a time slot where a sum of a ratio of customers visiting alone and a ratio of customers visiting in a group of two is relatively higher than that of remaining types;
displays a guide recommending arranging group tables without separating them in a time slot where a sum of a ratio of customers visiting in the group of three and a ratio of customers visiting in the group of four is relatively higher than that of remaining types; and
displays a guide recommending combining tables for two people to make a group table and arranging the same in a time slot where a ratio of customers visiting in the group of five or more is relatively higher than that of remaining types.

5. The system according to claim 1, wherein the AI learning model receives data on a gender, an age, and order information of visiting customers from the kiosk or the POS device as an input and outputs a gender and an age group that are relatively most frequent for each time slot, and
the processor provides a marketing strategy for an advertisement based on the outputted ratio.

6. The system according to claim 5, wherein the processor:
displays a guide to display an advertisement targeting females in 10s and 20s age groups on the kiosk and a table tablet device in a time slot where the females in the 10s and 20s age groups are relatively most frequent among visiting customers;
displays a guide to display an advertisement targeting males in 10s and 20s age groups on the kiosk and the table tablet device in a time slot where the males in the 10s and 20s age groups are relatively most frequent among visiting customers;
displays a guide to display an advertisement targeting females in 30s and 40s age groups on the kiosk and the table tablet device in a time slot where the females in the 30s and 40s age groups are relatively most frequent among visiting customers;
displays a guide to display an advertisement targeting males in 30s and 40s age groups on the kiosk and the table tablet device in a time slot where the males in the 30s and 40s age groups are relatively most frequent among visiting customers;
displays a guide to display an advertisement targeting females in 50s and 60s age groups on the kiosk and the table tablet device in a time slot where the females in the 50s and 60s age groups are relatively most frequent among visiting customers; and
displays a guide to display an advertisement targeting males in 50s and 60s age groups on the kiosk and the table tablet device in a time slot where the males in the 50s and 60s age groups are relatively most frequent among visiting customers.

7. The system according to claim 5, wherein the processor:
displays a guide recommending relatively lowering a height of the kiosk in a time slot in which a ratio of females among visiting customers is output as exceeding a specified level compared to a ratio of males; and
displays a guide recommending relatively raising the height of the kiosk in a time slot in which a ratio of males among visiting customers is output as exceeding a specified level compared to the ratio of females.

8. The system according to claim 1, wherein the processor:
classifies a first zone, in which a time occupied by a floating population exceeds a specified level, and a second zone, in which a time occupied by the floating population is less than the specified level within a specified space, using the AI learning model; and
outputs a gender and an age group that are relatively most frequent for each time slot by receiving data on gender, age, and order information of visiting customers from the kiosk or the POS device.

9. The system according to claim 8, wherein the processor:
determines a gender and an age group that are most frequent among customers based on a time slot; and
provides a guide such that an advertisement targeting the most frequent gender and age group is displayed in the first zone.

10. The system according to claim 8, wherein the processor:
determines a rank of a plurality of advertisements for each advertisement unit price;
provides a guide so that an advertisement having a highest advertisement unit price is arranged in the first zone; and
provides a guide so that an advertisement having a lowest advertisement unit price is arranged in the second zone.
